(19) United States
(12) Patent Application Publication
(10) Pub. No.: US 2019/0376484 A1
(43) Pub. Date: Dec. 12, 2019

(54) Vehicle Engine Electric Starter Motor with Multiple Speed Ratios

(71) Applicant: GM Global Technology Operations LLC, Detroit, MI (US)

(72) Inventors: Madhusudan Raghavan, West Bloomfield, MI (US); Neeraj S. Shidore, Novi, MI (US); Shawn H. Swales, Canton, MI (US)

(21) Appl. No.: 16/001,086

(22) Filed: Jun. 6, 2018

(51) Int. Cl. F02N 15/04; F02N 15/00; F16H 3/66

(52) U.S. Cl. CPC F02N 15/046; F02N 15/003; F16H 3/663; F02N 2200/041; F02N 2300/102; F16H 2200/2023; F16H 2200/2007; F16H 2200/2033; F16H 2200/2066; F16H 2200/2082; F16H 2200/0034

(57) ABSTRACT

A vehicle engine electric starter motor can bring a vehicle engine crankshaft up to a desired spinning speed prior to igniting the accompanying vehicle engine by way of multiple speed ratios. The vehicle engine electric starter motor includes a planetary gearset assembly. The planetary gearset assembly receives rotational drive input from an armature shaft, and transmits rotational drive output to an engine flywheel. Amid use of the vehicle engine electric starter motor, the vehicle engine electric starter motor can provide a first speed ratio by way of the planetary gearset assembly between the rotational drive input and the rotational drive output in a first mode of operation. And the vehicle engine electric starter motor can provide a second speed ratio by way of the planetary gearset assembly between the rotational drive input and the rotational drive output in a second mode of operation.

### INTRODUCTION

The present disclosure relates to electric starter motors used in vehicle engines, and more particularly relates to vehicle engine electric starter motors with planetary gearset assemblies.

An electric starter motor is commonly equipped in a vehicle engine, such as an automotive internal combustion engine, in order to turn a crankshaft of the vehicle engine before igniting the engine and starting it to run. An electric starter motor is usually a part of a larger vehicle starting system that also includes an ignition switch, a battery, and an engine flywheel, among other components. An electric starter motor itself ordinarily includes a housing, a solenoid, an armature, a reduction gearset, an overrunning clutch, and a drive pinion as its primary components. Prior to starting the engine, an electric starter motor typically turns the crankshaft to a particular turning speed through a single speed ratio.

### SUMMARY

In an embodiment, a vehicle engine electric starter motor may include a planetary gearset assembly. The planetary gearset assembly receives rotational drive input from an armature shaft, and transmits rotational drive output to an engine flywheel. Amid use of the vehicle engine electric starter motor, the vehicle engine electric starter motor provides a first speed ratio by way of the planetary gearset assembly between the rotational drive input and the rotational drive output in a first mode of operation. And the vehicle engine electric starter motor provides a second speed ratio by way of the planetary gearset assembly between the rotational drive input and the rotational drive output in a second mode of operation.

In an embodiment, the rotational drive input from the armature is the sole rotational drive input received by the planetary gearset assembly. And the rotational drive output to the engine flywheel is the sole rotational drive output transmitted by the planetary gearset assembly.

In an embodiment, the planetary gearset assembly may include a first sun gear, a second sun gear, a first set of planet gears, and a second set of planet gears. The first sun gear receives rotational drive input from the armature shaft. The first set of planet gears receives drive input from the first sun gear. And the second set of planet gears receives drive input from the second sun gear.

In an embodiment, the planetary gearset assembly may further include a single ring gear that has meshing engagement with the first set of planet gears.

In an embodiment, the planetary gearset assembly may further include a single planet gear carrier that supports revolution of the first set of planet gears, and that supports revolution of the second set of planet gears.

In an embodiment, the vehicle engine electric starter motor may further include a first brake and a second brake. The first brake, when prompted, can engage with the planetary gearset assembly. Similarly, when prompted, the second brake can engage with the planetary gearset assembly.

In an embodiment, when the first brake is engaged, the rotational movement of a ring gear of the planetary gearset assembly is halted. This provides the first speed ratio in the first mode of operation of the vehicle engine electric starter motor.

In an embodiment, when the second brake is engaged, the rotational movement of a sun gear of the planetary gearset assembly is halted. This provides the second speed ratio in the second mode of operation of the vehicle engine electric starter motor.

In an embodiment, amid use of the vehicle engine electric starter motor, the first brake is initially engaged in order to provide the first speed ratio in the first mode of operation. And subsequently, the second brake is engaged in order to provide the second speed ratio in the second mode of operation. After that, the vehicle engine is ignited in the second mode of operation of the vehicle engine electric starter motor.

In an embodiment, the first speed ratio of the first mode of operation is approximately five-to-one (5:1) input rotational speed to output rotational speed.

In an embodiment, the second speed ratio of the second mode of operation is approximately two-to-one (2:1) input rotational speed to output rotational speed.

In an embodiment, amid use of the vehicle engine electric starter motor, at the second speed ratio in the second mode of operation, the rotational drive output transmitted to the engine flywheel can bring a vehicle engine crankshaft to a spinning speed of approximately 1,000 revolutions per minute (RPM) prior to ignition of the vehicle engine.

In an embodiment, a vehicle engine electric starter motor may include a planetary gearset assembly, a first brake, and a second brake. The planetary gearset assembly may include a first sun gear, a first set of planet gears, a second sun gear, and a second set of planet gears. The first set of planet gears receives drive input from the first sun gear, and the second set of planet gears receives drive input from the second sun gear. The first brake can be engaged with the planetary gearset assembly, and the second brake can be engaged with the planetary gearset assembly. Amid use of the vehicle engine electric starter motor, the first brake is initially engaged with the planetary gearset assembly in order to provide a first speed ratio by way of the planetary gearset assembly in a first mode of operation. And the second brake is subsequently engaged with the planetary gearset assembly in order to provide a second speed ratio by way of the planetary gearset assembly in a second mode of operation.

In an embodiment, when the first brake is initially engaged in order to provide the first speed ratio in the first mode of operation, the second brake is not engaged with the planetary gearset assembly.

In an embodiment, when the second brake is subsequently engaged in order to provide the second speed ratio in the second mode of operation, the first brake is not engaged with the planetary gearset assembly.

In an embodiment, the first speed ratio in the first mode of operation is effected by way of the first sun gear and the first set of planet gears.

In an embodiment, the second speed ratio in the second mode of operation is effected by way of the second sun gear and the second set of planet gears.

In an embodiment, engagement of the first brake halts rotational movement of a ring gear of the planetary gearset assembly in order to provide the first speed ratio in the first mode of operation of the vehicle engine electric starter motor.

In an embodiment, engagement of the second brake halts rotational movement of the second sun gear of the planetary gearset assembly in order to provide the second speed ratio in the second mode of operation of the vehicle engine electric starter motor.

In an embodiment, a vehicle engine electric starter motor may include a planetary gearset assembly, a first brake, and a second brake. The planetary gearset assembly may include a first sun gear, a first set of planet gears, a second sun gear, a second set of planet gears, a ring gear, and a planet gear carrier. The first set of planet gears receives drive input from the first sun gear. The second set of planet gears receives drive input from the second sun gear. The ring gear has meshing engagement with the first set of planet gears. The planet gear carrier supports revolution of the first set of planet gears, and supports revolution of the second set of planet gears. The first brake can be engaged with the ring gear of the planetary gearset assembly. The second brake can be engaged with the second sun gear of the planetary gearset assembly. Amid use of the vehicle engine electric starter motor, the first brake is initially engaged with the ring gear in order to provide a first speed ratio by way of the planetary gearset assembly in a first mode of operation. And the second brake is subsequently engaged with the second sun gear in order to provide a second speed ratio by way of the planetary gearset assembly in a second mode of operation.

### BRIEF DESCRIPTION OF THE DRAWINGS

One or more aspects of the disclosure will hereinafter be described in conjunction with the appended drawings, wherein like designations denote like elements, and wherein:

FIG. 1 is a schematic depiction of an embodiment of a vehicle engine electric starter motor;

FIG. 2 is a schematic depiction of an embodiment of a planetary gearset assembly of the vehicle engine electric starter motor of FIG. 1;

FIG. 3 depicts yet another view of the planetary gearset assembly of FIG. 2;

FIG. 4 is a schematic depiction of another embodiment of a vehicle engine electric starter motor; and

FIG. 5 is a graphical representation of the operation of the vehicle engine electric starter motor of FIG. 1, with time plotted on an x-axis and revolutions per minute (RPM) plotted on the y-axis.

### DETAILED DESCRIPTION

Referring to the drawings, a vehicle engine electric starter motor 10 (hereafter, starter motor) is designed and constructed to improve the starting functionality and quality of an accompanying vehicle engine 12, such as an automotive internal combustion engine. The starter motor 10 is equipped with more than one speed ratio in order to increase a spinning speed of a vehicle engine crankshaft 14 before the vehicle engine 12 is ignited, and without exceeding a revolution per minute (RPM) limit of the starter motor 10. The vehicle engine 12 can hence exhibit a quieter and smoother starting procedure. The starter motor 10 brings about this increased speed and enhanced starting procedure by way of a planetary gearset assembly 16 outfitted to carry out multiple speed ratios. Such improved starting functionality and quality is often sought at the time of initial ignition of the vehicle engine 12, at subsequent ignition re-starts for hybrid electric vehicles (HEVs), as well as at other times of vehicle operation. The starter motor 10 is described below in the context of an automotive application, yet could be equipped in non-automotive applications as well.

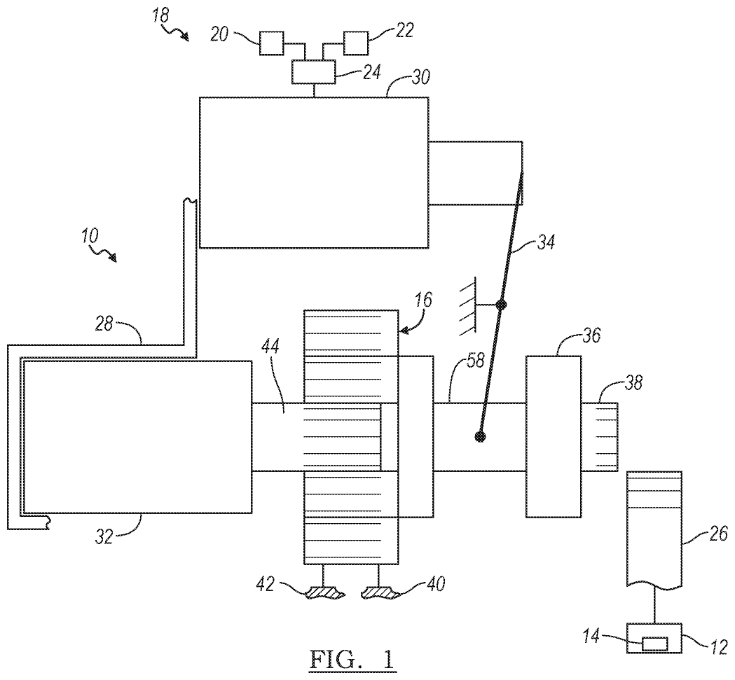

With reference to FIG. 1, the starter motor 10 is one component of a larger vehicle starting system 18. The vehicle starting system 18 can have various designs and constructions and components in various examples depending upon, among other possible influences, the particular vehicle in which the starting system 18 is installed and the architecture of the accompanying electrical control system. The schematic depiction of FIG. 1 presents but one example representation. The vehicle starting system 18 can include a battery 20, an ignition switch 22, a start relay 24, and an engine flywheel 26. Still, the vehicle starting system 18 could include different and/or other components in other examples.

The starter motor 10 can have different designs, constructions, and components in different embodiments depending upon—among other possible factors—the designs and constructions and components of the vehicle starting system 18 in which the starter motor 10 is equipped. In the embodiment of FIGS. 1-3, the starter motor 10 includes a housing 28, a solenoid 30, an armature 32, a shift lever 34, an overrunning clutch 36, and a drive pinion 38. In general, skilled artisans will appreciate how these components are arranged and how they function in a starter motor, and hence a detailed description of each component is not provided here. Still, in other embodiments the starter motor 10 could have different and/or other components. Unlike previous starter motors, the starter motor 10 presented in the figures includes the planetary gearset assembly 16, a first brake 40, and a second brake 42 that together furnish the starter motor 10 with a first speed ratio in a first mode of operation and with a second speed ratio in a second mode of operation, as set forth below.

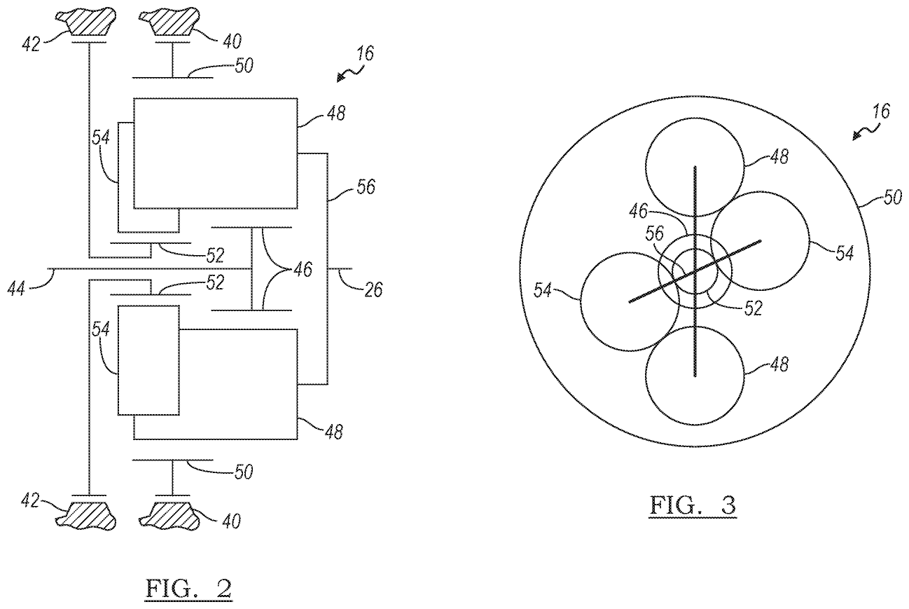

The planetary gearset assembly 16 constitutes the reduction gearset of the starter motor 10 and, through its gearset arrangement and in conjunction with the first and second brakes 40 and 42, provides the multi-speed ratio functionality of the starter motor 10. The planetary gearset assembly 16 can have different designs, constructions, and components in different embodiments depending upon—among other possible factors—the number of speed ratios provided and the magnitude of the provided speed ratios. In the embodiment of FIGS. 1-3, the planetary gearset assembly 16 is situated between the armature 32 and the overrunning clutch 36/drive pinion 38 and, due to this location, receives direct and immediate rotational drive input from an armature shaft 44 and, downstream, transmits rotational drive output to the engine flywheel 26 via teeth-to-teeth meshing engagement between the drive pinion 38 and the engine flywheel 26. These are the sole rotational drive input and outputs that pass through the planetary gearset assembly 16—in other words, the planetary gearset assembly 16 has a single input and a single output. The planetary gearset assembly 16 can have different gearset arrangements to effect its gear reduction and multi-speed ratio functionality. In an embodiment, and referring particularly to FIGS. 2 and 3, the planetary gearset assembly 16 includes a first sun gear 46, a first set of planet gears 48, a ring gear 50, a second sun gear 52, a second set of planet gears 54, and a planet gear carrier 56. The first sun gear 46 can be mounted directly on the armature shaft 44 and co-rotates therewith. The first set of planet gears 48 has teeth-to-teeth meshing engagement with the first sun gear 46 and thereby receives direct revolving drive input from the first sun gear 46. In this embodiment, there is a pair of individual first planet gears 48, but there could be a different quantity of them in other embodiments. The ring gear 50 has teeth-to-teeth meshing engagement with the first set of planet gears 48. The ring gear 50 constitutes the sole ring gear component of the planetary gearset assembly 16 in the embodiment of FIGS. 2 and 3.

Furthermore, the second sun gear 52 has teeth-to-teeth meshing engagement with the second set of planet gears 54, and thereby receives direct rotational drive input from the second set of planet gears 54. The second set of planet gears 54 has teeth-to-teeth meshing engagement with the first set of planet gears 48 and thereby receives direct revolving drive input from the first set of planet gears 48. In this embodiment, there is a pair of individual second planet gears 54, but there could be a different quantity of them in other embodiments. Unlike the first set of planet gears 48, the second set of planet gears 54 lacks engagement with the ring gear 50. Lastly, the planet gear carrier 56 supports revolution of the first and second sets of planet gears 48, 54 about their respective axes. The planet gear carrier 56 constitutes the sole planet gear carrier component of the planetary gearset assembly 16 in the embodiment of FIGS. 2 and 3. The planet gear carrier 56 itself rotates and delivers the rotational drive output of the planetary gearset assembly 16. A shaft 58 (FIG. 1) extends from the planet gear carrier 56 and co-rotates with the planet gear carrier 56. In a similar manner, the drive pinion 38 can be mounted directly on the shaft 58 and co-rotates with the shaft 58.

The first brake 40 is interengaged with the planetary gearset assembly 16 in order to effect the first speed ratio in the first mode of operation. The first brake 40 can have different designs, constructions, and components in different embodiments depending upon—among other possible factors—the design and construction and components of the planetary gearset assembly 16. In a specific example, the first brake 40 can be a band that, when prompted, is actuated by a solenoid for engagement with the planetary gearset assembly 16. Still, the first brake 40 can be of other types and can be actuated by other means. In the embodiment of FIGS. 1-3, the first brake 40 is operatively associated with the ring gear 50 and, when engaged therewith, halts rotational movement of the ring gear 50. The cessation of movement of the ring gear 50 is retained for as long as the first brake 40 is actuated and engaged.

Similarly, the second brake 42 is interengaged with the planetary gearset assembly 16 in order to effect the second speed ratio in the second mode of operation. The second brake 42 can have different designs, constructions, and components in different embodiments depending upon—among other possible factors—the design and construction and components of the planetary gearset assembly 16. In a specific example, the second brake 42 can be a band that, when prompted, is actuated by a solenoid for engagement with the planetary gearset assembly 16. Still, the second brake 42 can be of other types and can be actuated by other means. In the embodiment of FIGS. 1-3, the second brake 42 is operatively associated with the second sun gear 52 and, when engaged therewith, halts rotational movement of the second sun gear 52. The cessation of movement of the second sun gear 52 is retained for as long as the second brake 42 is actuated and engaged.

When the starter motor 10 is employed in application in the starting system 18, the starter motor 10 initially runs in the first mode of operation with the planetary gearset assembly 16 set to provide the first speed ratio. Here, the first brake 40 is engaged and the rotational movement of the ring gear 50 is halted; meanwhile, the second brake 42 lacks engagement in the first mode of operation and instead remains disengaged. With the ring gear's rotational movement being stationary, the first sun gear 46, first set of planet gears 48, second sun gear 52, second set of planet gears 54, and planet gear carrier 56 all experience their respective movements, resulting in a rotational drive output of the planetary gearset assembly 16 at the first speed ratio. The first speed ratio, in a specific example, can be approximately five-to-one (5:1) input rotational speed received by the planetary gearset assembly 16 to output rotational speed transmitted by the planetary gearset assembly 16; still, in other examples the magnitude of the first speed ratio may differ. At the first speed ratio, in this example, the starter motor 10 can bring the spinning speed of the vehicle engine crankshaft 14 up to approximately 500 RPM; still, in other examples the spinning speed of the vehicle engine crankshaft 14 can be brought to other values in the first speed ratio.

Further, once the starter motor 10 reaches a threshold RPM when enacting the first speed ratio in the first mode of operation, the starter motor 10 subsequently shifts to the second mode of operation with the planetary gearset assembly 16 set to provide the second speed ratio. Here, the second brake 42 is engaged and the rotational movement of the second sun gear 52 is halted; meanwhile, the first brake 40 lacks engagement in the second mode of operation and instead remains disengaged. With the second sun gear's rotational movement being stationary, the first sun gear 46, first set of planet gears 48, ring gear 50, second set of planet gears 54, and planet gear carrier 56 all experience their respective movements, resulting in a rotational drive output of the planetary gearset assembly 16 at the second speed ratio. The second speed ratio, in a specific example, can be approximately two-to-one (2:1) input rotational speed received by the planetary gearset assembly 16 to output rotational speed transmitted by the planetary gearset assembly 16; still, in other examples the magnitude of the second speed ratio may differ. At the second speed ratio, in this example, the starter motor 10 can bring the spinning speed of the vehicle engine crankshaft 14 up to approximately 1,000 RPM; still, in other examples the spinning speed of the vehicle engine crankshaft 14 can be brought to other values in the second speed ratio. In this example, once the vehicle engine crankshaft 14 has come to a spinning speed of approximately 1,000 RPM, the vehicle engine 12 can be ignited for a quieter and smoother starting procedure; still, ignition can occur at other RPM values.

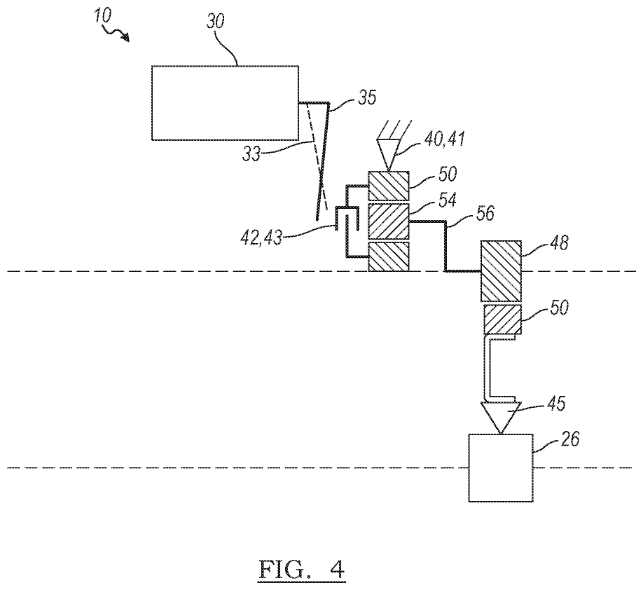

Another embodiment of the starter motor 10 is presented by FIG. 4. In this embodiment, the first brake 40 is in the form of a one-way clutch 41 and the second brake 42 is in the form of a friction clutch 43. The one-way clutch 41 is engageable with the ring gear 50, and the friction clutch 43 is engageable with the second sun gear 52 and/or the second set of planet gears 54. The ring gear 50 transmits rotational drive output to the engine flywheel 26 via a one-way overrunning clutch 45 that overruns once engine ignition occurs. The friction clutch 43 is actuatable by the solenoid 30 of the starter motor 10, thus obviating the need for an additional solenoid dedicated to prompting brake engagement. Engagement of the friction clutch 43 is represented in FIG. 4 by broken line 33, while disengagement of the friction clutch 43 is represented by solid line 35. In use, when the friction clutch 43 engages with the second sun gear 52 and/or the second set of planet gears 54, the one-way clutch 41 automatically releases and becomes disengaged from the ring gear 50. The friction clutch 43 could further be configured to engage any two components of the planetary gearset assembly 16. Furthermore, the one-way overrunning clutch 45 could be omitted, whereby the solenoid 30 would be employed to actuate engagement of the first set of planet gears 48 and employing an alternative means (e.g., a second solenoid) to actuate engagement of the friction clutch 43.

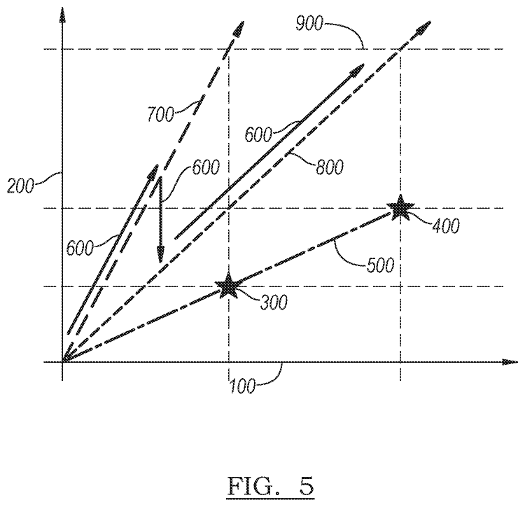

As described, the starter motor 10 brings about the increased spinning speed of the vehicle engine crankshaft 14 and the enhanced starting procedure without exceeding an RPM limit of the starter motor 10. Different starter motors can have different RPM limits. An example is set forth in the graphical representation of FIG. 5. In FIG. 5, time is plotted on an x-axis 100 and revolutions per minute (RPM) are plotted on a y-axis 200. The reference numeral 300 denotes vehicle engine ignition using a previously-known starter motor with a single speed ratio, and the reference numeral 400 denotes the ignition of the vehicle engine 12 using the starter motor 10 as set forth above. Ignition 300 occurs when an associated crankshaft has a spinning speed of about 500 RPM, and ignition 400 occurs when the vehicle engine crankshaft 14 has a spinning speed of about 1,000 RPM. A vehicle engine crankshaft spinning speed is denoted by the trace line of reference numeral 500. Furthermore, in the graphical representation of FIG. 5, an output rotational speed of the starter motor 10 is denoted by the line marked by reference numeral 600. The output rotational speed of the starter motor 10 at the first speed ratio is denoted by the trace line of reference numeral 700, and the output rotational speed of the starter motor 10 at the second speed ratio is denoted by the trace line of reference numeral 800. The shift from the first speed ratio to the second speed ratio is demonstrated by the vertical step downward in the line 600 in the graph. Finally, the RPM limit of the starter motor 10 is denoted by the line marked by reference numeral 900. As illustrated in FIG. 5, the starter motor 10 brings the vehicle engine crankshaft 14 to a spinning speed of 1,000 RPM at the second speed ratio without exceeding the RPM limit of the starter motor 10.

It is to be understood that the foregoing is a description of one or more aspects of the disclosure. The disclosure is not limited to the particular embodiment(s) disclosed herein, but rather is defined solely by the claims below. Furthermore, the statements contained in the foregoing description relate to particular embodiments and are not to be construed as limitations on the scope of the disclosure or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A vehicle engine electric starter motor, comprising:
a planetary gearset assembly receiving rotational drive input from an armature shaft and transmitting rotational drive output to an engine flywheel;
wherein, during use of the vehicle engine electric starter motor, the vehicle engine electric starter motor provides a first speed ratio via the planetary gearset assembly between the rotational drive input and the rotational drive output in a first mode of operation, and provides a second speed ratio via the planetary gearset assembly between the rotational drive input and the rotational drive output in a second mode of operation.

2. The vehicle engine electric starter motor of claim 1, wherein the rotational drive input from the armature is the sole rotational drive input received by the planetary gearset assembly, and the rotational drive output to the engine flywheel is the sole rotational drive output transmitted by the planetary gearset assembly.

3. The vehicle engine electric starter motor of claim 1, wherein the planetary gearset assembly comprises:
a first sun gear receiving rotational drive input from the armature shaft;
a second sun gear;
a first set of planet gears receiving drive input from the first sun gear; and
a second set of planet gears receiving drive input from the second sun gear.

4. The vehicle engine electric starter motor of claim 3, wherein the planetary gearset assembly further comprises a single ring gear having meshing engagement with the first set of planet gears.

5. The vehicle engine electric starter motor of claim 3, wherein the planetary gearset assembly further comprises a single planet gear carrier supporting revolution of the first set of planet gears and supporting revolution of the second set of planet gears.

6. The vehicle engine electric starter motor of claim 1, further comprising a first brake engageable with the planetary gearset assembly, and a second brake engageable with the planetary gearset assembly.

7. The vehicle engine electric starter motor of claim 6, wherein engagement of the first brake halts rotational movement of a ring gear of the planetary gearset assembly in order to provide the first speed ratio in the first mode of operation of the vehicle engine electric starter motor.

8. The vehicle engine electric starter motor of claim 6, wherein engagement of the second brake halts rotational movement of a sun gear of the planetary gearset assembly in order to provide the second speed ratio in the second mode of operation of the vehicle engine electric starter motor.

9. The vehicle engine electric starter motor of claim 6, wherein, during use of the vehicle engine electric starter motor, the first brake is initially engaged in order to provide the first speed ratio in the first mode of operation of the vehicle engine electric starter motor, the second brake is subsequently engaged in order to provide the second speed ratio in the second mode of operation of the vehicle engine electric starter motor, and the vehicle engine is ignited in the second mode of operation of the vehicle engine electric starter motor.

10. The vehicle engine electric starter motor of claim 1, wherein the first speed ratio of the first mode of operation is approximately five-to-one (5:1) input rotational speed to output rotational speed.

11. The vehicle engine electric starter motor of claim 1, wherein the second speed ratio of the second mode of operation is approximately two-to-one (2:1) input rotational speed to output rotational speed.

12. The vehicle engine electric starter motor of claim 1, wherein, during use of the vehicle engine electric starter motor, at the second speed ratio in the second mode of operation, the rotational drive output transmitted to the engine flywheel can bring a vehicle engine crankshaft to a spinning speed of approximately 1,000 revolutions per minute (RPM) prior to ignition of the vehicle engine.

13. A vehicle engine electric starter motor, comprising:
a planetary gearset assembly including a first sun gear, a first set of planet gears receiving drive input from the first sun gear, a second sun gear, and a second set of planet gears receiving drive input from the second sun gear;
a first brake engageable with the planetary gearset assembly; and
a second brake engageable with the planetary gearset assembly;
wherein, during use of the vehicle engine electric starter motor, the first brake is initially engaged with the planetary gearset assembly in order to provide a first speed ratio via the planetary gearset assembly in a first mode of operation, and the second brake is subsequently engaged with the planetary gearset assembly in order to provide a second speed ratio via the planetary gearset assembly in a second mode of operation.

14. The vehicle engine electric starter motor of claim 13, wherein, when the first brake is initially engaged in order to provide the first speed ratio in the first mode of operation, the second brake lacks engagement with the planetary gearset assembly.

15. The vehicle engine electric starter motor of claim 13, wherein, when the second brake is subsequently engaged in order to provide the second speed ratio in the second mode of operation, the first brake lacks engagement with the planetary gearset assembly.

16. The vehicle engine electric starter motor of claim 13, wherein the first speed ratio in the first mode of operation is effected via the first sun gear and the first set of planet gears.

17. The vehicle engine electric starter motor of claim 13, wherein the second speed ratio in the second mode of operation is effected via the second sun gear and the second set of planet gears.

18. The vehicle engine electric starter motor of claim 13, wherein engagement of the first brake halts rotational movement of a ring gear of the planetary gearset assembly in order to provide the first speed ratio in the first mode of operation of the vehicle engine electric starter motor.

19. The vehicle engine electric starter motor of claim 13, wherein engagement of the second brake halts rotational movement of the second sun gear of the planetary gearset assembly in order to provide the second speed ratio in the second mode of operation of the vehicle engine electric starter motor.

20. A vehicle engine electric starter motor, comprising:
a planetary gearset assembly including a first sun gear, a first set of planet gears receiving drive input from the first sun gear, a second sun gear, a second set of planet gears receiving drive input from the second sun gear, a ring gear having meshing engagement with the first set of planet gears, and a planet gear carrier supporting revolution of the first set of planet gears and supporting revolution of the second set of planet gears;
a first brake engageable with the ring gear of the planetary gearset assembly; and
a second brake engageable with the second sun gear of the planetary gearset assembly;
wherein, during use of the vehicle engine electric starter motor, the first brake is initially engaged with the ring gear in order to provide a first speed ratio via the planetary gearset assembly in a first mode of operation, and the second brake is subsequently engaged with the second sun gear in order to provide a second speed ratio via the planetary gearset assembly in a second mode of operation.
